(19) United States
(12) Patent Application Publication
(10) Pub. No.: US 2026/0160993 A1
(43) Pub. Date: Jun. 11, 2026

(54) ACTUATOR FOR SCANNING MIRROR, OPTICAL SCANNING SYSTEM, AND LIDAR SYSTEM

(71) Applicant: inSync Resonance Inc, Fremont, CA (US)

(72) Inventor: Qin ZHOU, Fremont, CA (US)

(21) Appl. No.: 18/970,966

(22) Filed: Dec. 6, 2024

(51) Int. Cl. G02B 26/10; G01S 7/481; G02B 26/08

(52) U.S. Cl. CPC G02B 26/105; G01S 7/4814; G01S 7/4817; G02B 26/0833

(57) ABSTRACT

Provided are an actuator for a scanning mirror, an optical scanning system, and a LiDAR system. The actuator for the scanning mirror includes: a drive motor having an output shaft configured to rotate during operation; and a movement adjustment component having a movement input end connected to the output shaft of the drive motor. The movement adjustment component is configured to convert the rotation input by the output shaft of the drive motor into a reciprocating movement in a first predetermined direction. The movement adjustment component has a movement output end configured to be connected to a to-be-driven scanning mirror, to drive the to-be-driven scanning mirror to perform a reciprocating movement in the first predetermined direction. According to technical solutions of the present disclosure, performance requirements for the drive motor can be reduced, and implementation costs of a solution for driving the scanning mirror can be lowered.

### FIELD

The present disclosure relates to the field of light detection and ranging technologies, and more particularly, to an actuator for a scanning mirror, an optical scanning system, and a light detection and ranging (LiDAR) system.

### BACKGROUND

An optical scanning system can realize light detection and ranging. Usually, the optical scanning system incorporates one or more scanning mirrors to reflect a light beam emitted by a light source to a target region. In addition, the scanning mirror needs to be driven to perform a reciprocating movement in one or two directions to realize scanning by a reflected beam in a predetermined direction within the target region. For example, when the target region needs to be scanned in both a horizontal direction and a vertical direction, the scanning mirror needs to be controlled to perform reciprocating movements in the horizontal direction and in the vertical direction, respectively.

In the related art, the reciprocating movement of the scanning mirror is generally realized in a manner of directly driving the scanning mirror by a drive motor, which can maximize an effective scanning duration, but requires that a drive shaft of the drive motor can rotate in a forward direction and then rapidly reverse to rotate in a reverse direction, or rotate in the reverse direction and then rapidly reverse to rotate in the forward direction. The above-mentioned rapid reverse rotation process has a high requirement for performance of the drive motor. In addition, to achieve high-precision scanning, a high-precision angle sensing system is needed for measuring a rotation angle of the drive shaft, and closed-loop control is needed. Therefore, an actuator for a scanning mirror in the related art requires high precision and high performance of individual components of the conventional actuator for a scanning mirror and has a defect of high implementation costs.

### SUMMARY

The present disclosure aims to solve at least one of the technical problems in the related art. To this end, the present disclosure provides an actuator for a scanning mirror, an optical scanning system, and a LiDAR system, capable of reducing performance requirements for a drive motor and lowering implementation costs of a scanning mirror drive solution.

In a first aspect, an actuator for a scanning mirror is provided according to embodiments of the present disclosure. The actuator for the scanning mirror includes: a drive motor having an output shaft configured to rotate during operation, and a movement adjustment component including a driving member and a driven member. The driving member is connected to the output shaft of the drive motor and driven by the output shaft to rotate around an axis of the output shaft. The driven member cooperates with the driving member and is driven by the driving member to perform a reciprocating movement in a first predetermined direction, and the driven member is configured to be connected to a to-be-driven scanning mirror, to drive the to-be-driven scanning mirror to perform a reciprocating movement in the first predetermined direction. In the technical solutions according to embodiments of the present disclosure, since the movement adjustment component is provided, the rotation output by the drive motor in one direction is converted into the reciprocating movement in a predetermined direction, in such a manner that the drive motor has no need to switch directions rapidly. In this way, components such as an angle sensing system has no need to be mounted on the drive motor. The drive motor only needs to perform a uniform rotation in one direction, reducing requirements for the drive motor. Therefore, a need for device miniaturization and a cost reduction can be realized.

In some embodiments, the movement adjustment component further includes an output rod having a first end connected to the driven member and a second end directly connected to the to-be-driven scanning mirror.

In some embodiments, the reciprocating movement in the first predetermined direction includes a rectilinear reciprocating movement along a straight segment, the driven member being a driven rectilinear movement member.

Alternatively, in some other embodiments, the reciprocating movement in the first predetermined direction includes a swing reciprocating movement within a radius angle, the driven member being a driven swing member.

In some embodiments, the movement adjustment component is a cam structure or a four-bar linkage structure.

In some embodiments, the cam structure includes a cam and a driven rectilinear movement member cooperating with the cam, the cam having a rotation shaft coaxially arranged with the output shaft of the drive motor, and the driven rectilinear movement member being configured to drive the to-be-driven scanning mirror to perform a reciprocating movement along a straight segment.

In some embodiments, the driven rectilinear movement member is provided with a rotary disk at an end of the driven rectilinear movement member. The rotary disk is in rolling contact with the cam.

In some embodiments, the cam structure includes a cam and a driven swing member cooperating with the cam, the cam having a rotation shaft coaxially arranged with the output shaft of the drive motor, and the driven swing member being configured to drive the to-be-driven scanning mirror to perform a swing reciprocating movement within a radius angle.

In some embodiments, the four-bar linkage structure includes a crank, a rocker, and a movement connection rod. The crank has a rotation shaft coaxially arranged with the output shaft of the drive motor. The movement connection rod has a first end connected to a circumferential movement end of the crank and a second end connected to a swing end of the rocker. The rotation shaft of the crank is fixed to a fixed end of the rocker. The rocker is configured to drive the to-be-driven scanning mirror to perform a swing reciprocating movement within a radius angle.

In some embodiments, the four-bar linkage structure includes a crank, a movement connection rod, a slider, and a fixed rod. The crank has a rotation shaft coaxially arranged with the output shaft of the drive motor. The movement connection rod has a first end connected to a circumferential movement end of the crank and a second end connected to the slider. The slider is sleeved on the fixed rod, and the slider is configured to drive the to-be-driven scanning mirror to perform a rectilinear reciprocating movement along a straight segment.

In a second aspect, an optical scanning system is further provided according to embodiments of the present disclosure. The optical scanning system includes the actuator for the scanning mirror according to any one of above embodiments, and the scanning mirror connected to the driven member.

The optical scanning system includes the actuator for the scanning mirror having the above-mentioned structure that is configured to drive the scanning mirror and enable the scanning mirror to perform the reciprocating movement in the first predetermined direction. Since the actuator for the scanning mirror includes the movement adjustment component, the rotation output by the drive motor in one direction is converted into the reciprocating movement in the predetermined direction, in such a manner that the drive motor has no need to switch directions rapidly. In this way, components such as the angle sensing system has no need to be mounted on the drive motor. The drive motor only needs to rotate in one direction, reducing the requirements for the drive motor. Therefore, the need for the device miniaturization and the cost reduction can be realized.

In some embodiments, the scanning mirror is arranged on a micro-electro-mechanical system (MEMS). The actuator for the scanning mirror is configured to drive the MEMS to perform a reciprocating movement in a first predetermined direction, to enable the scanning mirror to perform the reciprocating movement in the first predetermined direction.

In some embodiments, the MEMS includes a drive component configured to drive the scanning mirror to perform a reciprocating movement in a second predetermined direction.

In a third aspect, a LiDAR system is further provided according to embodiments of the present disclosure. The LiDAR system includes a light source, a photodetector, a processor, and the above-mentioned optical scanning system. The photodetector is configured to receive at least part of reflected light from the target region and convert the at least part of the reflected light into an electrical signal. The processor is configured to obtain a laser point cloud from the target region based on the electrical signal.

According to the embodiments of the present disclosure, the actuator for the scanning mirror, the optical scanning system, and the LiDAR system are provided. In the actuator for the scanning mirror, instead of directly driving the scanning mirror by the drive motor, the movement adjustment component is arranged in the actuator for the scanning mirror and provides a movement manner adjustment. The movement adjustment component has a movement input end connected to the output shaft of the drive motor. The movement adjustment component is specifically configured to convert the rotation movement input by the output shaft of the drive motor into the reciprocating movement in the first predetermined direction, and output the above-mentioned reciprocating movement in the first predetermined direction at a movement output end of the movement adjustment component. In an exemplary embodiment of the present disclosure, the movement adjustment component has the movement output end configured to be connected to the to-be-driven scanning mirror, to drive the above-mentioned to-be-driven scanning mirror to perform the reciprocating movement in the first predetermined direction. According to the above-mentioned embodiments, the unidirectional rotation of the output shaft of the drive motor can be converted into the reciprocating movement in the first predetermined direction of the scanning mirror. In the embodiments of the present disclosure, by changing a manner of directly driving the scanning mirror by the drive motor to a manner of indirectly driving the scanning mirror by the drive motor, high-precision scanning can be realized without arranging an additional angle sensing system and without performing closed-loop control. Also, a need for a drive motor supporting rapid reversal is eliminated, and thus a relatively simple stepper motor can be used, which reduces performance requirements for the drive motor and effectively reduces costs. In addition, with the indirect driving manner, the movement adjustment component can be properly designed to enable the drive motor and the scanning mirror to be arranged in parallel to the scanning system, which reduces a height of the scanning system, facilitating realization of a design need for the device miniaturization.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic structural view of a scanning system in the related art.

FIG. 2 is a schematic structural view of an actuator for a scanning mirror according to some embodiments of the present disclosure.

FIG. 3 is a schematic structural view of an actuator for a scanning mirror according to some embodiments of the present disclosure.

FIG. 4 is a schematic structural view of an actuator for a scanning mirror according to some embodiments of the present disclosure.

FIG. 5 is a schematic view of a rectilinear reciprocating movement according to some embodiments of the present disclosure.

FIG. 6 is a schematic view of a swing reciprocating movement according to some embodiments of the present disclosure.

FIG. 7 is a schematic structural view of a movement adjustment component implemented as a cam structure according to some embodiments of the present disclosure.

FIG. 8 is a schematic structural view of a movement adjustment component implemented as a cam structure according to some embodiments of the present disclosure.

FIG. 9 is a schematic structural view of a movement adjustment component implemented as a four-bar linkage structure according to some embodiments of the present disclosure.

FIG. 10 is a schematic structural view of a movement adjustment component implemented as a four-bar linkage structure according to some embodiments of the present disclosure.

FIG. 11 is a schematic structural view of an optical scanning system according to some embodiments of the present disclosure.

FIG. 12 is a schematic structural view of a scanning mirror in the embodiment illustrated in FIG. 11.

FIG. 13 is a schematic structural view of a LiDAR system according to some embodiments of the present disclosure.

FIG. 14 is a schematic structural view of a LiDAR system according to some embodiments of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the embodiments of the present disclosure.

In technical solutions of using LiDAR for optical detection and ranging, an optical scanning system is generally used. The optical scanning system includes an actuator for a scanning mirror and a scanning mirror. A main function of the actuator for the scanning mirror is to drive the scanning mirror to perform a reciprocating movement in a predetermined direction. In this case, the scanning mirror can reflect a laser beam incident on a mirror surface of the scanning mirror, and enable a reflected beam to perform scanning on a target region at a predetermined frequency, so that the laser beam can be incident on the target region to be detected by the LiDAR. An optical receiver for a LiDAR system can be configured to receive the reflected beam from the above-mentioned target region, and perform functions such as object detection and ranging based on the above-mentioned reflected beam.

In the related art, the above-mentioned actuator for the scanning mirror mainly includes a drive motor. The drive motor is configured to directly drive the scanning mirror to perform the reciprocating movement in the predetermined direction. However, due to a need for the reciprocating movement, the drive motor in this case needs to be continuously reversed in response to reaching a predetermined angle. In this way, on the one hand, a high-precision angle sensing system needs to be provided to measure a rotation angle of an output shaft of the drive motor, in such a manner that a timely reversal can be performed when the drive motor is rotated to the predetermined angle. Also, in the process, closed-loop control is required. On the other hand, the drive motor needs to have satisfactory performance to realize a quick switch of a rotation direction when a reversal is needed, for a reason that only a drive motor with satisfactory performance can realize a rapid reversal. The above-mentioned performance requirements and an arrangement of the high-precision angle sensing system increase costs of the actuator for the scanning mirror. In addition, when the actuator for the scanning mirror mentioned above is used in the optical scanning system, the scanning mirror is directly driven using the output shaft of the drive motor. Therefore, during an assembly of the actuator for the scanning mirror, as illustrated in FIG. 1, a schematic structural view of a scanning system in the related art, a drive motor 11 and a scanning mirror 12 are stacked on each other in an extension direction of the output shaft of the drive motor. In addition, in consideration of a height of a fixed base 13 of the drive motor 11, the scanning system may have an excessive height, which is disadvantageous to realizing a design need for device miniaturization.

According to the embodiments of the present disclosure, an actuator for a scanning mirror is provided. In the actuator for a scanning mirror, instead of directly driving a scanning mirror by a drive motor, a movement adjustment component is arranged in the actuator for the scanning mirror and provides a movement manner adjustment. The movement adjustment component has a movement input end connected to an output shaft of the drive motor. The movement adjustment component is specifically configured to convert a rotation input by the output shaft of the drive motor into a reciprocating movement in a first predetermined direction, and output the above-mentioned reciprocating movement in the first predetermined direction at a movement output end of the movement adjustment component. In an exemplary embodiment of the present disclosure, the movement adjustment component has the movement output end that can be configured to be connected to a to-be-driven scanning mirror, to drive the above-mentioned to-be-driven scanning mirror to perform the reciprocating movement in the first predetermined direction. According to the above-mentioned embodiments, the unidirectional rotation of the output shaft of the drive motor can be converted into the reciprocating movement in the first predetermined direction of the scanning mirror. In the embodiments of the present disclosure, by changing a manner of directly driving the scanning mirror by the drive motor to a manner of indirectly driving the scanning mirror by the drive motor, high-precision scanning can be realized without arranging an additional angle sensing system and without performing closed-loop control. Also, a need for a drive motor supporting rapid reversal is eliminated, and thus a relatively simple stepper motor can be used, which reduces performance requirements for the drive motor and effectively reduces costs. In addition, with the indirect driving manner, the movement adjustment component can be properly designed to enable the drive motor and the scanning mirror to be arranged in parallel in the scanning system, which reduces a height of the scanning system, facilitating realization of the design need for the device miniaturization.

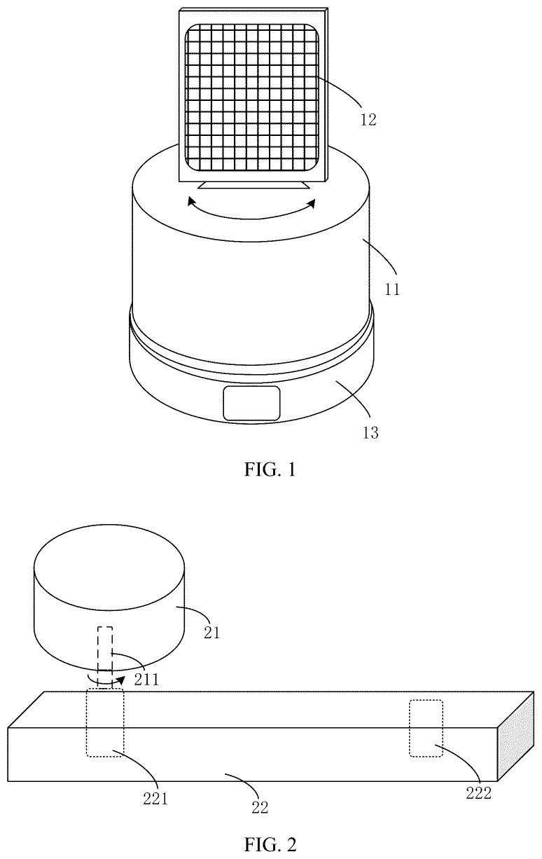

FIG. 2 is a schematic structural view of an actuator for a scanning mirror according to some embodiments of the present disclosure. As illustrated in FIG. 2, the actuator for the scanning mirror includes a drive motor 21 and a movement adjustment component 22. An output shaft 211 of the drive motor 21 is configured to rotate during operation. The drive motor 21 may be selected from various types of motors, such as a stepper motor. The movement adjustment component 22 can adjust a movement manner. In an exemplary embodiment of the present disclosure, the movement adjustment component 22 has a movement input end 221 connected to an output shaft 211 of the drive motor 21, and can be configured to convert the rotation input by the output shaft 211 of the drive motor 21 into a reciprocating movement in a first predetermined direction and output the above-mentioned reciprocating movement in the first predetermined direction by means of a movement output end 222 of the movement adjustment component 22.

In the embodiments of the present disclosure, the movement output end 222 of the movement adjustment component 22 may be connected to the to-be-driven scanning mirror, to enable the movement output end 222 of the movement adjustment component 22 to drive the to-be-driven scanning mirror to perform the reciprocating movement in the first predetermined direction.

In the embodiments of the present disclosure, the movement adjustment component may be implemented in a variety of ways. However, in terms of function implementations, the movement adjustment component 22 may mainly include two parts, namely, a driving member and a driven member. The driving member serves as the movement input end 221 in the above-mentioned embodiments, while the driven member serves as the above-mentioned movement output end 222. In addition, the driving member and the driven member can cooperate with each other in operation.

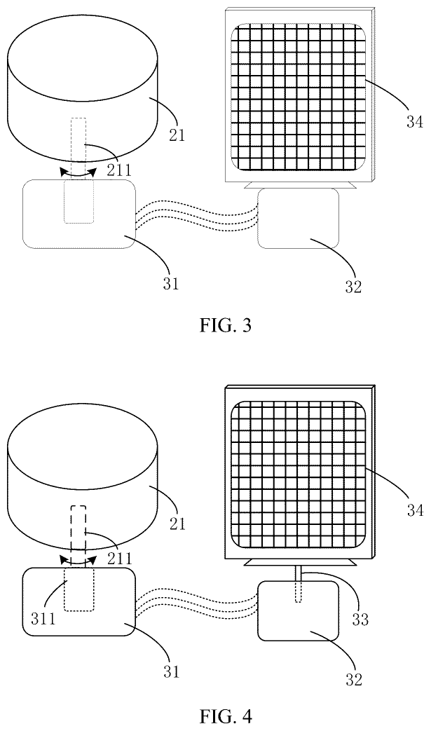

FIG. 3 is a schematic structural view of an actuator for a scanning mirror according to some embodiments of the present disclosure. As illustrated in FIG. 3, the movement adjustment component 22 in FIG. 2 further includes a driving member 31 and a driven member 32. In addition, the driving member 31 may be connected to the output shaft of the drive motor. In another exemplary embodiment of the present disclosure, as illustrated in FIG. 4, the driving member 31 may include a rotation shaft 311. The rotation shaft 311 may be arranged coaxially with the output shaft of the drive motor, in such a manner that the driving member 31 is configured to rotate in synchronization with the output shaft of the drive motor during operation. In addition, in the movement adjustment component, by cooperating the driving member 31 with the driven member 32, the driving member 31 can not only drive the driven member 32 to move but also drive the driven member 32 to perform the reciprocating movement in the first predetermined direction.

Those skilled in the art can design a mechanical structure based on the above-mentioned functional needs for the movement adjustment component 22, to enable the driving member 31 and the driven member 32 in the movement adjustment component 22 to realize corresponding functions. Some specific implementations are also provided in the following embodiments of the present disclosure.

In some embodiments, driven by the driving member 31, the driven member 32 may perform the reciprocating movement in the first predetermined direction. In this way, the driven member 32 can be connected to a to-be-driven scanning mirror 34 to drive the to-be-driven scanning mirror 34 to perform the reciprocating movement in the first predetermined direction. In a specific implementation process, an output end of the driven member 32 of the movement adjustment component can be directly connected to the to-be-driven scanning mirror 34. Or, as illustrated in FIG. 4, the movement adjustment component 22 in FIG. 2 may further include an output rod 33 in addition to the driving member 31 and the driven member 32 that are illustrated in FIG. 3. In this case, the output end of the driven member 32 is connected to a first end of the output rod 33, and a second end of the output rod 33 is directly connected to the to-be-driven scanning mirror 34. The output rod 33 may be of various shapes, such as a straight shape, a ring shape, a polyline shape, or the like. During operation, the entire output rod 33 performs the reciprocating movement in the first predetermined direction together with the output end of the driven member 32, while the output rod 33 drives the scanning mirror 34 to perform the same reciprocating movement in the first predetermined direction.

In the embodiments of the present disclosure, the reciprocating movement in the first predetermined direction may include a variety of different situations, e.g., a rectilinear reciprocating movement along a straight segment or a swing reciprocating movement within a radius angle.

FIG. 5 is a schematic view of a rectilinear reciprocating movement according to some embodiments of the present disclosure. As illustrated in FIG. 5, the rectilinear reciprocating movement may be performed by a center point of the scanning mirror 34 between two points A and B on a predetermined straight segment. In addition, the scanning mirror 34 may be positioned at a predetermined angle α relative to the straight segment throughout a scanning process, in which α may be selected as 90° or other acute angles. The first predetermined direction in this embodiment includes both a direction from A to B and a direction from B to A. The scanning mirror 34 is driven to move along point A to point B and then to move from point B to point A in one cycle, which realizes scanning of the light beam reflected by the scanning mirror 34 in a predetermined region. In some embodiments, the driven member may be directly connected to the center point of the scanning mirror 34, or the second end of the output rod 33 in FIG. 4 may be directly connected to the center point of the scanning mirror 34, to drive the scanning mirror 34 to perform the above-mentioned rectilinear reciprocating movement along the straight segment.

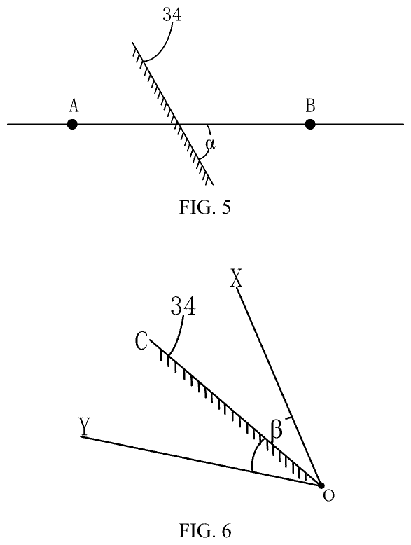

FIG. 6 is a schematic view of a swing reciprocating movement according to some embodiments of the present disclosure. As illustrated in FIG. 6, the swing reciprocating movement may be performed by the scanning mirror 34, which has an end fixed at, e.g., point O, driven to reciprocate within a radius angle of β of a circle centered at point O, in which β is defined by radii OX and radii OY that pass through the center O. The scanning mirror 34 is driven to move from OX to OY and then from OY to OX in one cycle, which realizes scanning of the light beam reflected by the scanning mirror 34 in the predetermined region. In some embodiments, one end of the scanning mirror 34 may be fixed at the point O. The driven member or the second end of the output rod 33 in FIG. 4 may be connected to other parts of the scanning mirror 34 other than point O, such as another end C of the scanning mirror 34 or the center point of the scanning mirror 34, to drive the scanning mirror 34 to perform the reciprocating movement within the radius angle of β.

The movement adjustment component in the above embodiments of the present disclosure may be implemented as a cam structure or a four-bar linkage structure. When the cam structure is adopted, the driving member is a cam, and the driven member may be a driven rectilinear movement member or a driven swing member.

In particular, the reciprocating movement in the first predetermined direction has been described in the above embodiments, which may be the rectilinear reciprocating movement along the straight segment or the swing reciprocating movement within the radius angle. That is, a reciprocating rotation around a fixed point corresponds to the above two situations. The driven member in the embodiments of the present disclosure may be the driven rectilinear movement member or the driven swing member. In the embodiments of the present disclosure, since each of the driven rectilinear movement member and the driven swing member can realize the reciprocating movement in the first predetermined direction, corresponding contour curves can be designed on the cam, and then the driven rectilinear movement member or the driven swing member is in contact with a surface of the cam to convert a rotation of the cam into a reciprocating movement of the cam along a straight segment or a reciprocating movement of the cam within the radius angle. In addition, in some embodiments, an elastic member such as a spring may be disposed at a position where the driven rectilinear movement member or the driven swing member is in contact with the cam, to realize close contact between the driven rectilinear movement member or the driven swing member and the cam and effectively reduce wear and tear.

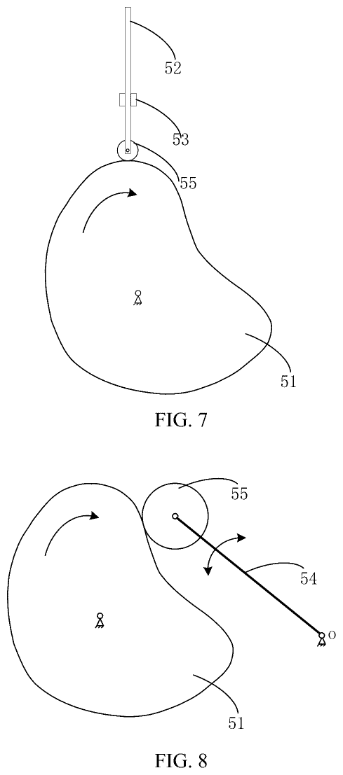

In some embodiments, as illustrated in FIG. 7, a technical solution of implementing the driven rectilinear movement member as a push rod is provided. As illustrated in FIG. 7, and in conjunction with FIG. 5 or FIG. 6, the movement adjustment component includes a cam 51 and a push rod 52. The push rod 52 is the driven rectilinear movement member that is position-limited in a rectilinear position-limiting member 53. The rectilinear position-limiting member 53 can limit the push rod 52 to move only along the straight segment without swinging in other directions, etc. In this case, when rotating around a rotation axis of the cam 51, the cam 51 continuously pushes the push rod 52 to perform the reciprocating movement along the straight segment. Through fixedly connecting the push rod 52 to the scanning mirror 34 such as connecting one end of the push rod 52 to the center point of the scanning mirror 34 in FIG. 5, or through fixing the scanning mirror 34 to the push rod 52 to enable the push rod 52 and the scanning mirror 34 to be integrally formed, or through fixing the scanning mirror 34 to the push rod 52 by means of another intermediate fixed connection structure but positioning the scanning mirror 34 outside a plane where the cam 51 and the push rod 52 are located, or through other methods, the push rod 52 can drive the reciprocating movement of the scanning mirror 34 along the straight segment. In addition, a contour curve of the cam 51 can be designed to regulate a movement law of the push rod 52 when the push rod 52 performs the reciprocating movement along the straight segment. When the push rod 52 is connected to the scanning mirror, the contour curve of the cam can be designed based on a specific demand for a movement law of the scanning mirror during operation.

In another exemplary embodiment of the present disclosure, as illustrated in FIG. 7, a rotary disk 55 may be arranged at an end of the push rod 52 in contact with the cam 51. During a rotation of the cam 51, the rotary disk 55 is driven to rotate while pushing the push rod 52 to perform the reciprocating movement along the straight segment. Since the rotary disk 55 is provided, wear between the push rod 52 and the cam 51 can be effectively reduced.

In some embodiments, as illustrated in FIG. 8, a technical solution of driving the scanning mirror to perform the reciprocating movement in the first predetermined direction using the driven swing member is provided. As illustrated in FIG. 8, the movement adjustment component includes the cam 51, a swing rod 54, and the rotary disk 55. The swing rod 54 and the rotary disk 55 together form the driven swing member. The swing rod 54 has an end fixed at the center O and another end provided with the rotary disk 55. An edge of the rotary disk 55 is abutted with the cam 51. A rotation shaft of the rotary disk 55 is fixed to the swing rod 54. In this way, when the cam 51 rotates around the rotation axis of the cam 51, the rotary disk 55 and the swing rod 54 can be pushed to rotate around the center O and a rotation angle can be formed. Through fixedly connecting the swing rod 54 to the scanning mirror 34, such as connecting one end of the swing rod 54 to an end C of the scanning mirror 34 in FIG. 6, through fixing the scanning mirror 34 to the swing rod 54 to enable the swing rod 54 and the scanning mirror 34 to be integrally formed, through fixing the scanning mirror 34 to the swing rod 54 by means of another intermediate fixed connection structure but positioning the scanning mirror 34 outside a plane where the cam 51 and the swing rod 54 are located, or through other methods, the swing rod 54 can drive the reciprocating movement of the scanning mirror 34 within the radius angle. In addition, the contour curve of the cam 51 can be designed to obtain specific rotation angles and a demand for a movement law of the driven swing member formed by the rotary disk 55 and the swing rod 54.

In some embodiments, the above-mentioned movement adjustment component may further be the four-bar linkage structure. The four-bar linkage structure may convert the rotation movement into the swing reciprocating movement within the radius angle or the rectilinear reciprocating movement along the straight segment.

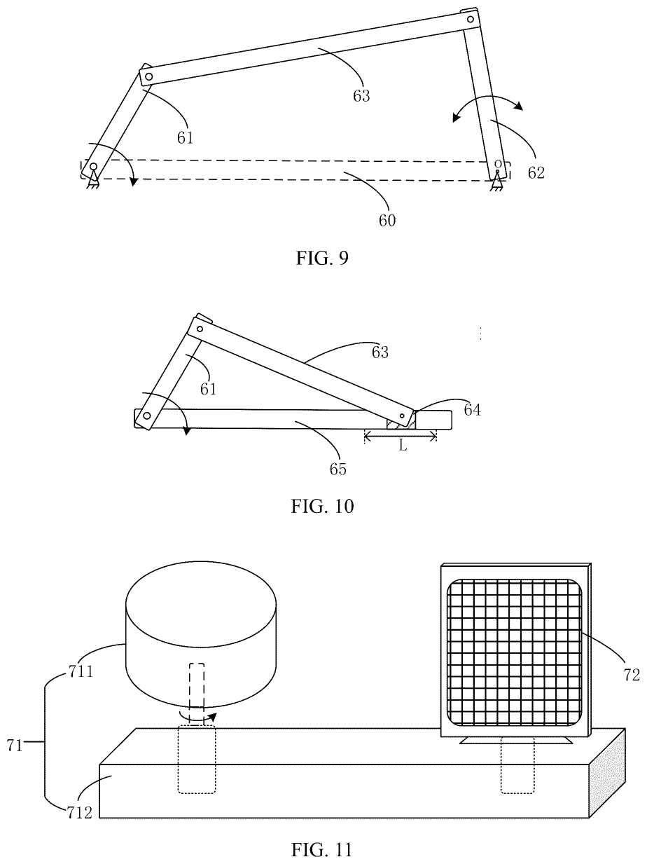

In an exemplary embodiment of the present disclosure, when the rotation movement is converted into the swing reciprocating movement within the radius angle using the four-bar linkage structure, the above four-bar linkage structure may be a crank-rocker structure. A crank in the crank-rocker structure serves as the driving member while a rocker in the crank-rocker structure serves as the driven swing member. As illustrated in FIG. 9, the crank-rocker structure includes a crank 61, a rocker 62, and a movement connection rod 63. The crank 61 has a rotation shaft coaxially arranged with the output shaft of the drive motor. The movement connection rod 63 has a first end connected to a circumferential movement end of the crank 61 and a second end connected to a swing end of the rocker 62. The rotation shaft of the crank 61 is fixed to a fixed end of the rocker 62. A fixed point of the rocker 62 is point O. In some embodiments, a fixed connection rod 60 may be arranged to fix the rotation shaft to the fixed end of the rocker 62. Or when the four-bar linkage structure is fixed to a mounting support, the rotation shaft of the crank 61 and the fixed end of the rocker 62 are fixed to the mounting support. The mounting support serves as the fixed connection rod, and thus the fixed connection rod 60 may be omitted.

Since the crank 61 has the rotation shaft coaxially arranged with the output shaft of the drive motor, the rotation shaft of the crank 61 can synchronously rotate with an output shaft of an output motor. In this way, when the crank-rocker structure described above is in operation, the rotation shaft of the crank 61 can drive, by means of the movement connection rod 63, the swing end of the rocker 62 to perform the reciprocating movement during the rotation of the crank 61, allowing the swing end of the rocker 62 to perform the reciprocating movement within the radius angle β of a circle centered at the point O. In some embodiments, through fixedly connecting the rocker 62 to the scanning mirror 34 such as fixing the scanning mirror 34 in FIG. 6 to the rocker 62, through forming the rocker 62 as a part of the scanning mirror 34 to enable the rocker 62 and the scanning mirror 34 to be integrally formed, through fixing the scanning mirror 34 to the rocker 62 by means of another intermediate fixed connection structure but positioning the scanning mirror 34 outside a plane where the crank 61 and the rocker 62 are located, or through other methods, a reciprocating movement of the to-be-driven scanning mirror 34 can be realized during driving the crank-rocker structure to operate.

In some embodiments, the above-mentioned crank-rocker structure may also be deformed to obtain a crank-slider structure. The crank-slider structure can be used to convert the rotation into the rectilinear reciprocating movement along the straight segment. A crank in the crank-slider structure is used as the driving member while a slider in the crank-slider structure is used as the driven rectilinear movement member. As illustrated in FIG. 10, the crank-slider structure provided in FIG. 10 includes the crank 61, the movement connection rod 63, a slider 64, and a fixed rod 65. The crank 61 has a rotation shaft coaxially arranged with the output shaft of the drive motor. The movement connection rod 63 has the first end connected to the circumferential movement end of the crank 61 and the second end connected to the slider 64. The slider 64 may be arranged around the fixed rod 65 or arranged inside the fixed rod 65, as long as the slider 64 moves within a straight segment of the fixed rod 65 in a length direction of the fixed rod 65, such as a straight segment L illustrated in FIG. 10. Also, the slider 64 can be configured to be fixedly connected to the to-be-driven scanning mirror 34 in FIG. 5 to drive the scanning mirror 34 to perform the rectilinear reciprocating movement within the straight segment. Since the crank 61 has the rotation shaft coaxially arranged with the output shaft of the drive motor, the rotation shaft of the crank 61 can synchronously perform the rotation with the output shaft of the output motor. In this way, when the crank-slider structure in the above embodiments of the present disclosure is in operation, the rotation shaft of the crank 61 can drive, by means of the movement connection rod 63, the slider 64 to perform the reciprocating movement during the rotation of the crank 61, allowing the slider 64 to perform the reciprocating movement within a straight segment AB. In some embodiments, through fixedly connecting the slider 64 to the scanning mirror 34 such as fixing the scanning mirror 34 in FIG. 5 to the slider 64, through forming the slider 64 as a part of the to-be-driven scanning mirror 34 to enable the slider 64 and the to-be-driven scanning mirror 34 to be integrally formed, through fixing the scanning mirror 34 to the slider 64 by means of another intermediate fixed connection structures but positioning the scanning mirror 34 outside a plane where the crank 61 and the slider 64 are located, or through other methods, the reciprocating movement of the to-be-driven scanning mirror 34 can be realized during driving the crank-rocker structure to operate.

In the above embodiments of the present disclosure, the movement manner is adjusted using the cam structure or the four-bar linkage structure. The rotation is adjusted to the rectilinear reciprocating movement along the straight segment or the swing reciprocating movement within the radius angle. In this way, the light beam can be projected in a target region in a scanning manner even when the output shaft of the drive motor only outputs the rotation. Therefore, neither a high-cost drive motor capable of rapid reversal nor an additional angle detection system and a closed-loop control system are required, which can lower costs. In some embodiments, the output shaft of the above-mentioned drive motor may perform a uniform rotation during operation. In this case, required operation characteristics of the reciprocating movement are obtained by designing the movement adjustment component. Or, a speed curve of the rotation may be predefined based on the required operation characteristics of the reciprocating movement, in such a manner that the output shaft of the drive motor can perform the rotation along a predefined speed curve through controlling the operation of the drive motor.

The embodiments of the present disclosure further provide an optical scanning system. FIG. 11 is a schematic structural view of an optical scanning system according to some embodiments of the present disclosure. As illustrated in FIG. 11, the optical scanning system includes an actuator 71 for a scanning mirror 72 and the scanning mirror 72. The actuator 71 for the scanning mirror 72 may be the actuator for the scanning mirror described in any of the above embodiments in FIG. 2 to FIG. 10. The actuator 71 for the scanning mirror 72 is configured to drive the scanning mirror 72 to perform the reciprocating movement in the first predetermined direction. In an exemplary embodiment of the present disclosure, the above-mentioned actuator for the scanning mirror 71 includes not only a drive motor 711 but also a movement adjustment component 712. The drive motor 711 has an output shaft performing a rotation during operation. The movement adjustment component 712 has a movement input end connected to the output shaft of the drive motor, and is capable of converting the rotation input by the output shaft of the drive motor into the reciprocating movement along the first predetermined direction. In addition, the movement adjustment component 712 has an output end configured to be connected to a to-be-driven scanning mirror 72, to drive the to-be-driven scanning mirror 72 to perform the reciprocating movement in the first predetermined direction.

The optical scanning system according to the embodiments of the present disclosure can convert the rotation movement output by the output shaft of the drive motor into the reciprocating movement capable of driving the scanning mirror to operate in the first predetermined direction, in such a manner that the drive motor does not need to have a rapid reversal capability, reducing performance requirements for the drive motor. Further, neither an angle sensing system for quickly and accurately detecting the rotation angle of the output shaft of the drive motor nor the closed-loop control is required, greatly lowering the costs. In addition, in the related art, such as the technical solution illustrated in FIG. 1 of using the drive motor to directly drive the scanning mirror, the drive motor and the scanning mirror need to be stacked. Compared to the related art, during a movement manner change performed by the movement adjustment component in the technical solutions according to the embodiments of the present disclosure, a rotation axis of the rotation may be offset from a position where the reciprocating movement occurs in the first predetermined direction, so that the scanning mirror and the drive motor can be arranged in parallel. In this case, a height of the entire scanning system can be reduced to achieve a height reduction of the entire scanning system, which facilitates the device miniaturization.

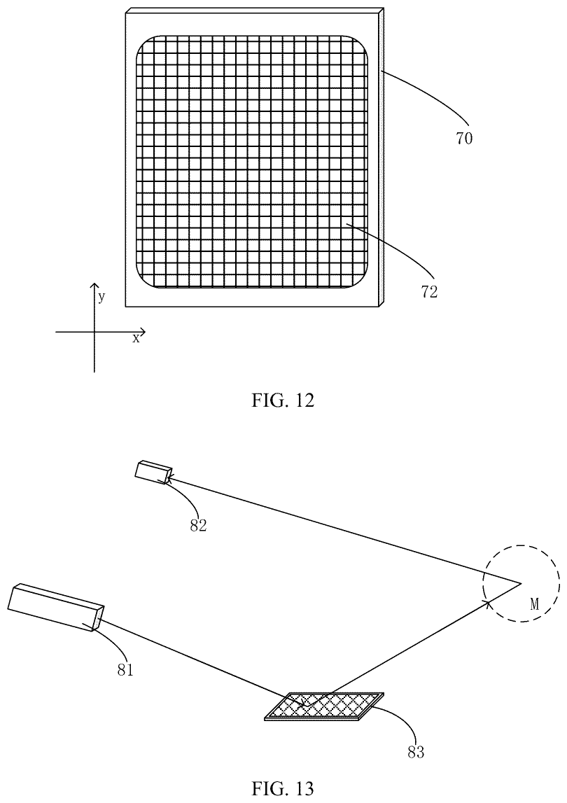

In the scanning system, the above-mentioned scanning mirror may be a mirror having a reflective function. The scanning mirror drive system can drive the mirror to perform the reciprocating movement to adjust a scanning range of the mirror. FIG. 12 is a schematic structural view of a scanning mirror according to an embodiment of the present disclosure. As illustrated in FIG. 12, the scanning mirror 72 may be arranged on a MEMS 70. The scanning mirror 72 may be a single mirror arranged on the MEMS or a plurality of mirrors arranged on the MEMS. The plurality of mirrors form the scanning mirror together. In another exemplary embodiment of the present disclosure, a reflective mirror may be formed on an upper surface of the MEMS through coating.

In addition, the above-mentioned scanning mirror can be driven by the actuator for the scanning mirror to perform scanning in the first predetermined direction. In terms of scanning demands of the scanning system, scanning in two different directions is generally required, e.g., the above-mentioned scanning in the first predetermined direction and scanning in a second predetermined direction. In this way, the reflected light beam of the scanning mirror can ultimately perform scanning in both a horizontal direction and a vertical direction in the target region. In another exemplary embodiment of the present disclosure, when the above reciprocating movements in the first predetermined direction and in the second predetermined direction are both reciprocating movements within predetermined straight segments, directions of the straight segments may be an x-axis direction and a y-axis direction illustrated in FIG. 12, respectively. When the above reciprocating movements in the first predetermined direction and in the second predetermined direction are both reciprocating movements within the radius angles, directions of angular velocity vectors of rotations when the reciprocating movements are performed are the x-axis direction and the y-axis direction, respectively. The above two schemes can realize that the laser beam is ultimately reflected onto the target region and performs the scanning in the target region.

For realizing the above scanning in the second predetermined direction, the drive component may be arranged on the MEMS and can be configured to drive the scanning mirror to perform the reciprocating movement in the second predetermined direction. In a specific embodiment, a plurality of mirrors may be formed on the MEMS. The plurality of mirrors form the scanning mirror together. The drive component is divided into a plurality of drive units. Each of the plurality of mirrors is provided with a drive unit corresponding to the mirror. The plurality of drive units is configured to synchronously drive respective mirrors, to drive the scanning mirror to perform the reciprocating movement in the second predetermined direction.

The embodiments of the present disclosure further provide the LiDAR system. The LiDAR system is configured to perform optical detection and ranging. FIG. 13 is a schematic structural view of a LiDAR system according to some embodiments of the present disclosure. As illustrated in FIG. 13, the LiDAR system includes a light source 81, a photodetector 82, and the above-mentioned optical scanning system 83. A laser beam emitted by the light source 81 is reflected to a target region M by a scanning mirror of the above-mentioned optical scanning system 83. In addition, the photodetector 82 is configured to receive at least part of reflected light from the target region M and convert the at least part of the reflected light into an electrical signal. Further, a processor may be provided. The processor is configured to obtain a laser point cloud from the target region based on the electrical signal output by the photodetector. Therefore, the light detection and ranging can be realized.

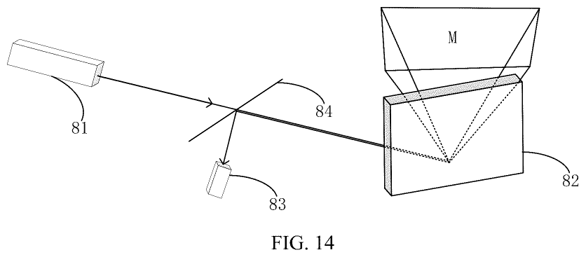

FIG. 14 is a schematic structural view of a LiDAR system according to some embodiments of the present disclosure. As illustrated in FIG. 14, the LiDAR system also includes the light source 81, the photodetector 82, and the optical scanning system 83, with a difference that, unlike a paraxial technical solution adopted in FIG. 13, a coaxial technical solution is adopted in the embodiment illustrated in FIG. 14. In an exemplary embodiment of the present disclosure, the LiDAR system further includes a beam splitter 84. In this way, the laser beam emitted by the light source 81 is reflected by the scanning mirror to the target region M after sequentially passing through the beam splitter 84 and the scanning mirror of the optical scanning system 83, for scanning the target region M. The at least part of the reflected light from the target region M may pass through the scanning mirror of the above-mentioned optical scanning system 83 to the beam splitter 84. The reflected light is directed to the photodetector 82 by the beam splitter 84 to enable the photodetector 82 to convert the reflected light into an electrical signal. Further, the processor can be configured to obtain the laser point cloud from the target region based on the electrical signal output from the photodetector, where the processor is further provided in the system, to realize the light detection and ranging. The above-mentioned light source 81, the photodetector 82, and the beam splitter 84 according to this embodiment may also form a laser transceiver module to realize laser emission and detection.

Terms such as “first” and “second” in the specification of the present disclosure and the appended claims are used only to distinguish between similar objects, rather than to describe a particular order or sequence. It should be understood that the data as used can be interchanged where appropriate, to enable the embodiments of the present disclosure described herein to be implemented in an order other than that illustrated or described herein. Also, the objects distinguished by the terms such as “first” and “second” are usually objects of the same type. The quantity of the objects is not limited. For example, one or a plurality of first objects may be provided. In addition, “and/or” throughout the specification and appended claims indicates at least one of the objects associated with “and/or”. The character “/” generally indicates that the associated objects before and after the character are in an “or” relationship.

In the description of the present disclosure, it should be understood that, the orientation or the position indicated by terms such as “center”, “longitudinal”, “lateral”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation and the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In the description of the present disclosure, “first feature” and “second feature” may include one or more of these features.

In the description of the present disclosure, “plurality” means two or more.

In the description of the present disclosure, the first feature “on” or “under” the second feature may mean that the first feature is in direct contact with the second feature, or the first and second features are in indirect contact through another feature between them.

In the description of the present disclosure, the first feature “above” the second feature means that the first feature is directly above or obliquely above the second feature, or simply means that the level of the first feature is higher than that of the second feature.

Reference throughout this specification to “an embodiment”, “some embodiments”, “illustrative embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. An actuator for a scanning mirror, comprising:
a drive motor having an output shaft configured to rotate during operation; and
a movement adjustment component comprising a driving member and a driven member, the driving member being connected to the output shaft of the drive motor and driven by the output shaft to rotate around an axis of the output shaft, the driven member cooperating with the driving member and being driven by the driving member to perform a reciprocating movement in a first predetermined direction, and the driven member being configured to be connected to a to-be-driven scanning mirror, to drive the to-be-driven scanning mirror to perform a reciprocating movement in the first predetermined direction.

2. The actuator for the scanning mirror according to claim 1, wherein the movement adjustment component further comprises an output rod, the output rod having a first end connected to the driven member and a second end directly connected to the to-be-driven scanning mirror.

3. The actuator for the scanning mirror according to claim 1, wherein the reciprocating movement in the first predetermined direction comprises a rectilinear reciprocating movement along a straight segment, the driven member being a driven rectilinear movement member.

4. The actuator for the scanning mirror according to claim 1, wherein the reciprocating movement in the first predetermined direction comprises a swing reciprocating movement within a radius angle, the driven member being a driven swing member.

5. The actuator for the scanning mirror according to claim 1, wherein the movement adjustment component is a cam structure or a four-bar linkage structure.

6. The actuator for the scanning mirror according to claim 5, wherein the cam structure comprises a cam and a driven rectilinear movement member cooperating with the cam, the cam having a rotation shaft coaxially arranged with the output shaft of the drive motor, and the driven rectilinear movement member being configured to drive the to-be-driven scanning mirror to perform a rectilinear reciprocating movement along a straight segment.

7. The actuator for the scanning mirror according to claim 6, wherein the driven rectilinear movement member is provided with a rotary disk at an end of the driven rectilinear movement member, the rotary disk being in rolling contact with the cam.

8. The actuator for the scanning mirror according to claim 5, wherein the cam structure comprises a cam and a driven swing member cooperating with the cam, the cam having a rotation shaft coaxially arranged with the output shaft of the drive motor, and the driven swing member being configured to drive the to-be-driven scanning mirror to perform a swing reciprocating movement within a radius angle.

9. The actuator for the scanning mirror according to claim 5, wherein the four-bar linkage structure comprises a crank, a rocker, and a movement connection rod, wherein:
the crank has a rotation shaft coaxially arranged with the output shaft of the drive motor;
the movement connection rod has a first end connected to a circumferential movement end of the crank and a second end connected to a swing end of the rocker;
the rotation shaft of the crank is fixed to a fixed end of the rocker; and
the rocker is configured to drive the to-be-driven scanning mirror to perform a swing reciprocating movement within a radius angle.

10. The actuator for the scanning mirror according to claim 5, wherein the four-bar linkage structure comprises a crank, a movement connection rod, a slider, and a fixed rod, wherein:
the crank has a rotation shaft coaxially arranged with the output shaft of the drive motor;
the movement connection rod has a first end connected to a circumferential movement end of the crank and a second end connected to the slider; and
the slider is sleeved on the fixed rod, and the slider is configured to drive the to-be-driven scanning mirror to perform a rectilinear reciprocating movement along a straight segment.

11. An optical scanning system, comprising:
an actuator for a scanning mirror, wherein the actuator for the scanning mirror comprises:
a drive motor having an output shaft configured to rotate during operation; and
a movement adjustment component comprising a driving member and a driven member, the driving member being connected to the output shaft of the drive motor and driven by the output shaft to rotate around an axis of the output shaft, the driven member cooperating with the driving member and driven by the driving member to perform a reciprocating movement in a first predetermined direction; and
a scanning mirror connected to the driven member.

12. The optical scanning system according to claim 11, wherein:
the scanning mirror is arranged on a MEMS; and
the actuator for the scanning mirror is configured to drive the MEMS to perform a reciprocating movement in a first predetermined direction, to enable the scanning mirror to perform the reciprocating movement in the first predetermined direction.

13. The optical scanning system according to claim 12, wherein the MEMS comprises a drive component configured to drive the scanning mirror to perform a reciprocating movement in a second predetermined direction.

14. The optical scanning system according to claim 11, wherein the movement adjustment component further comprises an output rod having a first end connected to the driven member and a second end directly connected to the scanning mirror.

15. The optical scanning system according to claim 11, wherein the reciprocating movement in the first predetermined direction comprises a rectilinear reciprocating movement along a straight segment, the driven member being a driven rectilinear movement member.

16. The optical scanning system according to claim 11, wherein the reciprocating movement in the first predetermined direction comprises a swing reciprocating movement within a radius angle, the driven member being a driven swing member.

17. The optical scanning system according to claim 11, wherein the movement adjustment component is a cam structure or a four-bar linkage structure.

18. The optical scanning system according to claim 17, wherein the cam structure comprises a cam and a driven rectilinear movement member cooperating with the cam, the cam having a rotation shaft coaxially arranged with the output shaft of the drive motor, and the driven rectilinear movement member being configured to drive the scanning mirror to perform the reciprocating movement along a straight segment.

19. The optical scanning system according to claim 18, wherein the driven rectilinear movement member is provided with a rotary disk at an end of the driven rectilinear movement member, the rotary disk being in rolling contact with the cam.

20. A LiDAR system, comprising:
a light source;
a photodetector;
a processor; and
the optical scanning system according to claim 11, wherein:
a laser beam emitted by the light source is reflected to a target region by the optical scanning system;
the photodetector is configured to receive at least part of reflected light from the target region and convert the at least part of the reflected light into an electrical signal; and
the processor is configured to obtain a laser point cloud from the target region based on the electrical signal.
